(19) United States
(12) Patent Application Publication
(10) Pub. No.: US 2021/0019850 A1
(43) Pub. Date: Jan. 21, 2021

(54) Postal Mail Assessment System and Method

(71) Applicant: INTERNATIONAL BUSINESS MACHINES CORPORATION, Armonk, NY (US)

(72) Inventors: Elisabeth LEVRAU, White Plains, NY (US); Susann Marie KEOHANE, Austin, TX (US); Gauri KARVE, Cohoes, NY (US); Joseph CZAJKOWSKI, Carteret, NJ (US)

(21) Appl. No.: 16/512,833

(22) Filed: Jul. 16, 2019

(51) Int. Cl. G06Q 50/26; G06N 20/00; G06K 9/00

(52) U.S. Cl. CPC G06Q 50/26; G06K 2209/01; G06K 9/00442; G06N 20/00

(57) ABSTRACT

A method and system for forming an assessment of postal mail is provided. In one embodiment, the method includes receiving images of postal mail addressed to a user on one or more dates to form a mail history. Information from the received images is captured to determine at least information associated with a sender and a recipient. The captured information is added to the mail history. The method further includes analyzing the mail history to determine a plurality of characteristics associated with the postal mail addressed to the user. A machine-learning algorithm is applied to the analyzed mail history and the determined plurality of characteristics to form an assessment. Based on the assessment exceeding a threshold associated with a criteria, the method includes performing at least one action.

### BACKGROUND

The present invention relates to postal mail analysis, and, more particularly, to a system and method for postal mail assessment to detect anomalies.

The United States Postal Service (USPS) offers a service that allows residential users the ability to receive digital images of pieces of postal mail that are addressed to the user's address. The USPS digitally scans and images the front of letter-sized pieces of postal mail that are processed through the USPS's automated mail sorting equipment. The scanned images of the postal mail are provided to the users in advance of the delivery of the physical postal mail.

### SUMMARY

According to an embodiment, a method for forming an assessment of postal mail is provided. The method includes receiving images of postal mail addressed to a user on one or more dates to form a mail history. Information from the received images is captured to determine at least information associated with a sender and a recipient. The captured information is added to the mail history. The method further includes analyzing the mail history to determine a plurality of characteristics associated with the postal mail addressed to the user. A machine-learning algorithm is applied to the analyzed mail history and the determined plurality of characteristics to form an assessment. Based on the assessment exceeding a threshold associated with a criteria, the method includes performing at least one action.

In another form, a computer program product for forming an assessment of postal mail is provided. The computer program product includes a computer readable storage medium having program instructions embodied therewith, the program instructions are executable by a processor to cause the processor to perform a method that includes receiving images of postal mail addressed to a user on one or more dates to form a mail history. Information from the received images is captured to determine at least information associated with a sender and a recipient. The captured information is added to the mail history. The computer-executable method further includes analyzing the mail history to determine a plurality of characteristics associated with the postal mail addressed to the user. A machine-learning algorithm is applied to the analyzed mail history and the determined plurality of characteristics to form an assessment. Based on the assessment exceeding a threshold associated with a criteria, the computer-executable method includes performing at least one action.

In another form, a system for forming an assessment of postal mail is provided. The system includes at least one computer including a processor configured to perform a method that includes receiving images of postal mail addressed to a user on one or more dates to form a mail history. Information from the received images is captured to determine at least information associated with a sender and a recipient. The captured information is added to the mail history. The processor-implemented method further includes analyzing the mail history to determine a plurality of characteristics associated with the postal mail addressed to the user. A machine-learning algorithm is applied to the analyzed mail history and the determined plurality of characteristics to form an assessment. Based on the assessment exceeding a threshold associated with a criteria, the processor-implemented method includes performing at least one action.

Other systems, methods, features and advantages of the invention will be, or will become, apparent to one of ordinary skill in the art upon examination of the following figures and detailed description. It is intended that all such additional systems, methods, features and advantages be included within this description and this summary, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a schematic diagram of an example embodiment of a system for forming an assessment of postal mail.

FIG. 2 is a representative diagram of an example embodiment of received images of postal mail.

FIG. 3 is a block diagram of an example embodiment of a computing system for implementing techniques for forming an assessment of postal mail.

FIG. 4 is a representative diagram of an example embodiment of a piece of postal mail for assessment.

FIG. 5 is a flowchart of an example embodiment of a method for forming an assessment of postal mail.

### DETAILED DESCRIPTION

The USPS images each piece of postal mail processed through automated mail sorting equipment and allows users to obtain digital previews via email of their household postal mail prior to delivery. Currently, this capability is offered as a standard USPS service at no charge to the user.

According to the techniques for forming an assessment of postal mail described herein, the scanned images are obtained from the USPS for further analysis and evaluation to form the assessment. Postal mail, even just based on an analysis of the exterior of letters over time, can provide insights into a person's interactions, interests, relationships, and potential threats. Over time, changes in the type and frequency of postal mail can imply changes in finances, interpersonal relationships, and mental status. Anomalies to normal postal mail can be indicators of potential financial fraud or manipulation as well as potential mental health issues.

The scanned images of postal mail may be analyzed to detect known malicious, fraudulent, or undesirable mail content. They are also analyzed by multiple machine-learning or artificial intelligence (AI) analytic tools to detect changes to normal postal mail patterns, unusual content, and key type identification (such as past due bills, collection notices, and other events). The detection of anomalies based on the assessment of the postal mail may then be reported to other systems or individuals for further analysis, consolidation, or action.

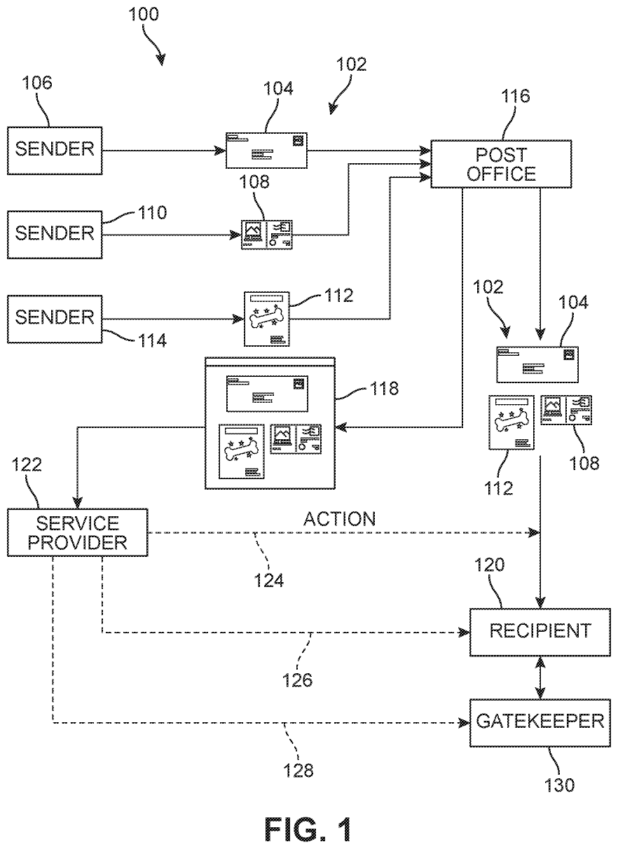

With reference now to FIG. 1, an example embodiment of a system 100 for forming an assessment of postal mail is shown. In some embodiments, a plurality of pieces of postal mail 102 are sent by one or more senders to an address associated with a user. In this embodiment, plurality of pieces of postal mail 102 include a letter 104 sent by a first sender 106, a postcard 108 sent by a second sender 110, and a magazine 112 sent by a third sender 114. It should be understood that plurality of pieces of postal mail 102 may include additional pieces of mail sent by additional senders.

In an example embodiment, plurality of pieces of postal mail 102 are processed through a post office 116. For example, in one embodiment, post office 116 is the USPS. In other embodiments, post office 116 may be any regional or national post office or a third party provider that is configured to receive and distribute postal mail. Upon receiving plurality of pieces of postal mail 102, post office 116 may use automated mail sorting equipment that scans the exterior of plurality of pieces of postal mail 102 to generate one or more scanned images 118 associated with each piece of mail of plurality of pieces of postal mail 102. In an example embodiment, a user may register with post office 116 to receive scanned images 118 of plurality of pieces of postal mail 102. For example, the USPS offers a service where registered users associated with a residential delivery address may elect to receive the scanned images of postal mail addressed to their residential delivery address. In some cases, a residential delivery address may be associated with one or more intended recipients of the postal mail for that address. For example, in this embodiment, a recipient 120 may be an intended recipient of plurality of pieces of postal mail 102.

According to the example embodiments described herein, a user may register with a service provider 122 to provide an assessment of postal mail addressed to the user's residential delivery address. The assessment provided by service provider 122 may include detection and/or notification of various types of anomalies associated with an analysis of the user's mail history, such as fraud, health issues, identification of events, etc.

In one embodiment, a user registers with service provider 122 using a username associated with a password or other verification mechanism and provides user information to service provider 122. For example, in one embodiment, the user is an intended recipient of postal mail, such as recipient 120. The user information can include, but is not limited to, a current residential address, one or more previous residential addresses, an email address for the user and/or other authorized parties who may interact with service provider 122, defined categories of postal mail to be flagged (e.g., known “bad actors” based on name and/or location, such as a sender return address or a postmark location, suspicious institutions or businesses, type of mail, etc.), and any other additional information that may be relevant for service provider 122 to identify and analyze the received postal mail, such as an expected delivery schedule for financial statements or recurring bills, etc.

In an example embodiment, once the user has registered with service provider 122, service provider 122 may receive scanned images 118 of plurality of pieces of postal mail 102 from post office 116. In some cases, scanned images 118 may be provided from post office 116 to service provider 122 via email. In other cases, scanned images 118 may be provided from post office 116 to service provider 122 via another mechanism, such as a link to a database where the images are stored or a direct file transfer. After scanning plurality of pieces of postal mail 102, post office 116 may then physically deliver each piece of mail of plurality of pieces of postal mail 102 to recipient 120 at the user's residential delivery address, for example, letter 104, postcard 108, and magazine 112. Additionally, the user or recipient 120 may also receive a copy of scanned images 118 via email or other mechanism.

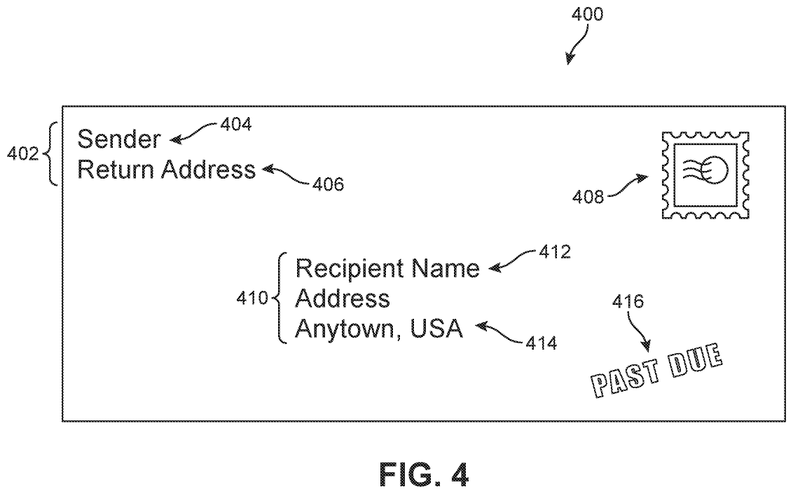

In some embodiments, service provider 122 may capture information from the received scanned images 118 provided by post office 116. The captured information may include various information obtained from scanned images 118 of the exterior of plurality of pieces of postal mail 102, including information obtained using optical character recognition (OCR) technology to identify text and/or handwriting, as well as other information that may be obtained using image recognition technology to identify logos, photos, size and shapes of pieces of mail, etc. In an example embodiment, the captured information from scanned images 118 received from post office 116 may include at least information associated with a sender and a recipient, such as a name or identity and/or an address associated with each sender and recipient. The captured information may include additional information, as detailed in reference to FIG. 4 below.

For example, information associated with a sender that is captured from the scanned image may also include information provided on the backside of the postal mail or other information extracted from the scanned images, such as markings which fraudulently imply the postal mail was sent by the U.S. government or other official governmental agency. In some cases, fraudulent or suspicious mail can include a reference to 18 U.S.C. § 1702 and a statement that it is “illegal to open other people's mail” or similar disclaimer. Other information associated with a sender may include the content or subject matter of the postal mail, such as identifying the subject matter of a magazine. For example, a magazine subscription for a subject directed towards teenagers or young adults sent to an elderly recipient may be information used to determine suspicious or fraudulent anomalies.

In some embodiments, the captured information from scanned images 118 is added to a mail history associated with a user. In this embodiment, scanned images 118 are associated with plurality of pieces of postal mail 102 sent to the user's address on a single day. Accordingly, the process of receiving scanned images, capturing information, and adding or updating the user's mail history may be repeated over a time period, such as days, weeks, months, etc. The accumulated mail history for a given user and/or recipient (e.g., recipient 120) may then be analyzed to determine a plurality of characteristics associated with the postal mail addressed to the user or recipient.

According to the principles of the example embodiments described herein, service provider 122 may use the captured information from scanned images 118 of plurality of pieces of postal mail 102 from post office 116, along with the stored information in the user's mail history and the determined plurality of characteristics, to form an assessment that can be used to detect and/or notify the user or other authorized parties of various types of anomalies associated with an analysis of the user's mail history, as will be explained in more detail below. In an example embodiment, a machine-learning algorithm may be applied to the mail history and the plurality of characteristics to form the assessment.

Based on the assessment exceeding a threshold associated with a criteria, service provider 122 may perform at least one action. An action that may be performed by service provider 122 may take different forms, depending on a user's settings or instructions with service provider 122. For example, as shown in FIG. 1, a first action 124 taken by service provider 122 may include preventing delivery of one or more pieces of plurality of pieces of postal mail 102 identified as fraudulent. First action 124 may include returning the identified fraudulent mail to the sender (e.g., returning letter 104 to first sender 106) or intercepting the identified fraudulent mail for further analysis or action by law enforcement. In some cases, service provider 122 may not have direct access to the postal mail of a user to take first action 124. In such cases, service provider 122 may inform the user or another party or entity, such as a relative, a gatekeeper 130, or a government or law enforcement agency, to take first action 124.

In some embodiments, a second action 126 taken by service provider 122 may include notifying or flagging one or more pieces of plurality of pieces of postal mail 102 identified as fraudulent. Second action 126 may include providing a notification to recipient 120 that a piece of mail intended for recipient 120 has been identified as being fraudulent or suspicious. In some cases, recipient 120 may still physically receive the identified fraudulent or suspicious piece of mail from post office 116 (e.g., letter 104). In these cases, however, because scanned images 118 are received from post office 116 before physical delivery of plurality of pieces of postal mail 102, the advance notification or warning from service provider 122 to recipient 120 may alert recipient 120 about the fraudulent or suspicious piece of mail before it is delivered. Recipient 120 may then decide the course of action, if any, to take upon receiving the identified fraudulent or suspicious piece of mail.

In another embodiment, a third action 128 taken by service provider 122 may include notifying or providing an alert to a gatekeeper 130. A user may appoint or elect gatekeeper 130 as a person, entity, or institution that is authorized and allowed to receive the user's assessment of their mail history from service provider 122. For example, gatekeeper 130 may be a relative or guardian, a medical or governmental institution (such as a hospital, rehabilitation center, prison, etc.), a facility (such as a retirement home or assisted living facility), or other appointed entity or individual. Gatekeeper 130 may then decide the course of action, if any, to take in response to the notification of the identified fraudulent or suspicious piece of mail. In some cases, gatekeeper 130 may be alerted to a status assessment of recipient 120 from service provider 122, such as a status associated with a health of recipient 120 (e.g., mental, physical, financial) or an event associated with recipient 120 (e.g., a birth, marriage, wedding, attending a conference, vacation, moving, new purchases, etc.).

In some embodiments, one of first action 124, second action 126, or third action 128 may be set as a default action for service provider 122, for example, as part of the user information provided when the user registers with service provider 122. In other embodiments, multiple actions of first action 124, second action 126, and third action 128 may be performed by service provider 122. That is, service provider 122 may intercept or prevent delivery of fraudulent mail (i.e., first action 124) and also notify recipient 120 (i.e., second action 126) of the fraudulent mail. Similarly, service provider 122 may notify both recipient 120 (i.e., second action 126) and gatekeeper 130 (i.e., third action 128) that a piece of mail intended for recipient 120 has been identified as being fraudulent or suspicious.

It should also be understood that additional actions may be performed by service provider 122 upon an assessment exceeding a threshold associated with a criteria for that assessment. Additionally, assessments having different criteria may include different actions performed by service provider 122. For example, a fraud assessment exceeding a threshold may include performing first action 124, whereas a status assessment exceeding a threshold may include performing third action 128.

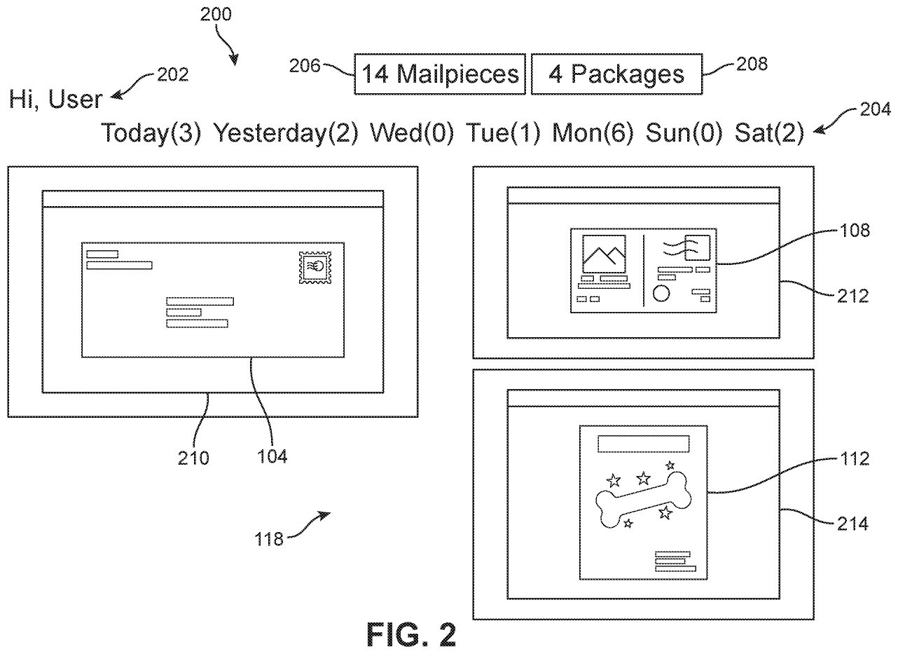

Referring now to FIG. 2, a representative diagram of an example embodiment of received scanned images 118 of postal mail from post office 116 is shown. In this embodiment, a user portal 200 associated with a user 202 (e.g., recipient 120) allows user 202 to see scanned images 118 of postal mail provided by post office 116. In an example embodiment, images of one or more pieces of postal mail 206 addressed to the residential delivery address of user 202 are shown. Additionally, in some embodiments, information associated with one or more packages 208 addressed to the residential delivery address of user 202 may also be shown. It should be understood that while the present embodiments are described in reference to analyzing and forming assessments of postal mail, in some embodiments, information associated with packages, such as packages 208, may also be used in forming an assessment.

In this embodiment, user 202 may view one or more pieces of postal mail 206 and/or packages 208 that are addressed to the residential delivery address of user 202 on each day of the week 204. As described above, in some embodiments, service provider 122 may use the received scanned images 118 of postal mail over a time period to form the mail history for user 202. In this embodiment, scanned images 118 of plurality of pieces of postal mail 102 from post office 116 represent the postal mail for one day. As shown in FIG. 2, scanned images 118 of plurality of pieces of postal mail 102 from post office 116 include a first image 210 of the scanned exterior of letter 104, a second image 212 of the scanned exterior of postcard 108, and a third image 214 of the scanned exterior of magazine 112. The captured information from scanned images 118 may be stored, along with a plurality of characteristics obtained from the captured information, as part of the mail history for user 202. Scanned images of postal mail addressed to the residential delivery address of user 202 for subsequent days may be similarly received by service provider 122 from post office 116. Service provider 122 captures information from these subsequent scanned images and adds the captured information and/or obtained characteristics to the stored mail history for user 202.

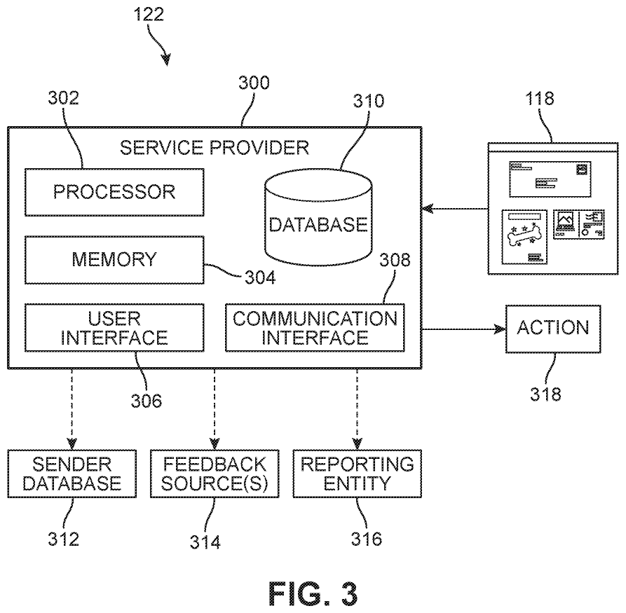

Referring now to FIG. 3, a block diagram of an example embodiment of a computing system 300 for implementing techniques for forming an assessment of postal mail is shown. In an example embodiment, computing system 300 may be associated with service provider 122. For example, computing system 300 may be hardware, software, or a combination of hardware and software that is used by service provider 122 to analyze the images of postal mail and form an assessment, according to the techniques described herein.

In an example embodiment, computing system 300 includes a processor 302 that is configured to implement the techniques for forming an assessment of postal mail described herein. For example, processor 302 of computing system 300 may execute instructions from a computer readable storage medium to implement the method of the present embodiments. Processor 302 may be associated with a personal computer and/or a server, as well any type of computing device. For example, in some embodiments, computing system 300 used by service provider 122 may be a remote server, a cloud platform, or a client-side personal computer. It should be appreciated that FIG. 3 provides only an illustration of one implementation and does not imply any limitations with regard to the environments in which different embodiments may be implemented. Many modifications to the depicted environment may be made.

As shown in FIG. 3, computing system 300 includes a memory 304, a user interface 306, a communication interface 308, and a database or persistent storage. A communications fabric (not shown) may also be provided for communications between processor(s) 302, memory 304, user interface 306, communication interface 308 and database 310. The communications fabric can be implemented with any architecture designed for passing data and/or control information between processors (such as microprocessors, communications and network processors, etc.), system memory, peripheral devices, and any other hardware components within a system. For example, the communications fabric may be implemented with one or more buses.

Memory 304 and database/persistent storage 310 are computer-readable storage media. In some embodiments, memory 304 may include a random access memory (RAM) and a cache memory. In general, memory 304 can include any suitable volatile or non-volatile computer-readable storage media. One or more programs may be stored in persistent storage 310 for access and/or execution by one or more of the respective processors 302 via one or more memories of memory 304. In this embodiment, database/persistent storage 310 includes a magnetic hard disk drive. Alternatively, or in addition to a magnetic hard disk drive, database/persistent storage 310 can include a solid state hard drive, a semiconductor storage device, read-only memory (ROM), erasable programmable read-only memory (EPROM), flash memory, or any other computer-readable storage media that is capable of storing program instructions or digital information.

Database 310 may also store information associated with one or more users of service provider 122. For example, the user information described above associated with a user (e.g., recipient 120) provided when the user registers with service provider 122 may be stored in database 310. Additional information associated with users, such as stored mail history, current and/or previous assessments, authorized parties who may interact with service provider 122, etc., may also be stored in database 310.

The media used by database/persistent storage 310 may also be removable. For example, a removable hard drive may be used for database/persistent storage 310. Other examples include optical and magnetic disks, thumb drives, and smart cards that are inserted into a drive for transfer onto another computer-readable storage medium that is also part of database/persistent storage 310.

Communication interface 308, in these examples, provides for communications with other processors, data processing systems, or devices. In an example embodiment, communication interface 308 may include one or more network interface cards. Communication interface 308 may provide communications through the use of either or both physical and wireless communications links.

User interface 306 allows for input and output of data with other devices that may be connected to computing system 300. For example, user interface 306 may provide a connection to external devices, such as a keyboard, keypad, a touch screen, an assistive or adaptive technology device, and/or some other suitable input device. External devices can also include portable computer-readable storage media such as, for example, thumb drives, portable optical or magnetic disks, and memory cards. Software and data used to practice embodiments of the present invention can be stored on such portable computer-readable storage media and can be loaded onto database/persistent storage 310 via user interface 306. User interface 306 may also connect to a display. The display provides a mechanism to display data to a user and may be, for example, a computer monitor.

In some embodiments, computing system 300 of service provider 122 may be configured to communicate with one or more other databases, computers, and/or services. For example, as shown in FIG. 3, service provider 122 may communicate with a sender database 312, one or more feedback sources 314, and/or a reporting entity 316. In some embodiments, sender database 312 may be a service or database that includes known bad senders (i.e., a “blacklist”). For example, known bad senders may be persons, companies, businesses or other entities that are known to send fraudulent or suspicious postal mail. Sender database 312 may include information associated with these known bad senders, such as names, addresses, geographic regions, type of postal mail, etc., for service provider 122 to use when analyzing potentially fraudulent or suspicious postal mail for a particular user.

In some embodiments, feedback sources 314 may be used by service provider 122 to improve or assist with analyzing the mail history for a user. For example, feedback sources 314 can include a feedback mechanism for other users or parties to provide input to service provider 122 about whether or not a particular piece of postal mail is or is not fraudulent or suspicious. Feedback sources 314 may provide validation to the machine-learning algorithm used by service provider 122 to analyze a user's mail history to form an assessment. The feedback provided by one or more feedback sources 314 can be used to train (or re-train) the machine-learning algorithm to improve the accuracy or success of assessments. In some cases, feedback sources 314 may include gamified or crowdsourced mechanisms, as well as comparisons with co-horts (e.g., users with similar characteristics as a particular user whose mail history is being analyzed).

For example, in the case of co-horts, by comparing other users with similar characteristics as a user, such as recipient 120, anomalies or potentially fraudulent or suspicious postal mail may be detected based on the previous analysis and assessments made in connection with the co-hort. Such comparisons using co-hort data and information may provide higher accuracy (i.e., fewer false positives and/or false negatives) and may also allow early detection of potentially fraudulent and/or suspicious postal mail.

In some embodiments, service provider 122 may also communicate with reporting entity 316. Reporting entity 316 may be a law enforcement or governmental agency, such as a police department, Federal Bureau of Investigation (FBI), postal inspection service, or other federal, state, or local agency or department, that may investigate or take further action when notified of fraudulent postal mail. Reporting entity 316 may also be a health care facility or provider, bank or financial institution, or other party that is notified of a health assessment for a user that indicates a potential health issue associated with the user's mental, physical, and/or financial health.

In an example embodiment, computing system 300 of service provider 122 is configured to receive scanned images 118 of plurality of pieces of postal mail 102 (as shown in FIG. 1) from post office 116 and capture information associated with the postal mail. For example, as described above, the captured information may include information associated with the sender and recipient, mailing and delivery dates, origination and destination addresses, postmark information (such as a processing location associated with post office 116), type of postal mail or packages (such as mail class, postage amount, additional services, etc.), and other information obtained from text, graphics, or handwriting on the exterior of the postal mail.

This captured information may be added the user's mail history, which can be analyzed by service provider 122 to determine a plurality of characteristics associated with the postal mail. For example, some characteristics may include known relationships between the sender and recipient, a frequency of delivery of postal mail between the sender and the recipient, subscription services (such as magazines, books, coins, etc.), and other characteristics determined based an analysis of the user's mail history over a time period.

In an example embodiment, computing system 300 of service provider 122 is configured to apply a machine-learning algorithm to a user's analyzed mail history and the plurality of characteristics associated with the postal mail addressed to the user to form an assessment. An example of a machine-learning algorithm that may be used to form the assessment is provided as follows below.

In one embodiment, the machine-learning algorithm may first perform an initial determination of whether or not the sender is valid or invalid. For example, the sender name and/or address may be compared to a known bad database (e.g., via sender database 312) or evaluated using other known metrics to determine known bad actors. A valid sender is a real person or company with a valid origination address. An invalid sender may be an imposter company or person (e.g., impersonating a governmental agency) and may also include an invalid or misleading origination address (e.g., address does not match addresses associated with sender). Additionally, other senders who are not fraudulent, but from whom it may be undesirable for a user or recipient to receive mail from can also be added to the known bad database. For example, some users (e.g., elderly or persons who have recently experienced loss of a family member) may be sensitive to cemetery advertising, or a particular user or recipient may become upset when receiving a letter from a specific person. In these case, these senders can also be added to the known bad database to provide an alert or flag postal mail that may be upsetting to receive.

Next, the machine learning algorithm may determine whether or not the sender is known or unknown to the recipient or user. For example, known senders may include companies, friends or relatives, or other parties from whom the recipient or user expects to receive postal mail. In some embodiments, known senders may be determined based on the analysis of the user's mail history. Additionally, in some embodiments, a known safe sender list may be used so that known senders are not flagged as potentially fraudulent or suspicious. Similarly, known unsafe or bad senders may be on an unsafe sender list to be immediately flagged as fraudulent or suspicious. Unknown senders may include postal mail sent by senders to the recipient or user where the relationship is not yet known or learned by the machine-learning algorithm.

Based on the initial determination above, the machine-learning algorithm may gather additional data points according to various conditions based on the sender identity. A first condition is when the sender is valid and known. If a piece of postal mail is received from a sender according to this first condition, the postal mail will only be flagged as potentially fraudulent or suspicious if the relationship between the sender and recipient has ended (e.g., user is no longer doing business with the sender, etc.) or if the postal mail is received at a frequency that does not match the frequency determined based on the user's mail history. For example, a financial statement that historically arrives only quarterly is received at an earlier date.

A second condition is when the sender is valid, but unknown. If a piece of postal mail is received from a sender according to this second condition, the postal mail may be flagged as potentially fraudulent or suspicious if the mail is associated with a flagged category, such as government, financial, or health related. If the postal mail is received from a sender that has started a new relationship with the user or recipient (i.e., a new credit card, etc.), then the machine learning algorithm may learn that the sender is known during subsequent analysis of the user's mail history.

Next, a third condition is when the sender is invalid and known. A piece of postal mail received from a sender that is known to be invalid (i.e., a bad actor), the mail will immediately be flagged as potentially fraudulent or suspicious. Additionally, information associated with the postal mail from the known, invalid sender may be provided to other parties, such as sender database 312 and/or a reporting entity 316, which may be helpful in learning and/or tracking similar fraudulent or suspicious postal mail.

A fourth condition is when the sender is invalid and unknown. A piece of postal mail received from a sender that is unknown and appears to be invalid will be flagged as potentially fraudulent or suspicious. Other conditions may be applied by the machine learning algorithm, such as a hierarchy of fraud detection, unexpected mailing or delivery frequency, suspicious origination addresses, various thresholds for different criteria for flagging the postal mail as potentially fraudulent or suspicious, and/or a volume of postal mail received.

Any one or more of the pieces of postal mail flagged by the machine-learning algorithm according to the conditions described above may then be validated to determine whether or not it is fraudulent or suspicious. For example, service provider 122 may send the images of the flagged mail to the user or recipient to notify or alert the user of the potentially fraudulent or suspicious mail. Service provider 122 may also or optionally contact an authorized party or entity on behalf of the user, such as gatekeeper 130, to determine whether or the flagged mail is fraudulent or suspicious. Feedback sources 314 may also or optionally provide validation of whether or not the flagged mail is fraudulent or suspicious.

Based on the assessment made by the machine-learning algorithm using the analyzed mail history and the determined plurality of characteristics, service provider 122 may perform an action 318. Action 318 may include one or more of first action 124, second action 126, and third action 128 as described above in reference to FIG. 1. Action 318 may also include other actions based on the determined assessment exceeding a threshold associated with a criteria.

In some embodiments, the assessment may be a fraud assessment and/or a status assessment. In the case of a fraud assessment, a threshold associated with a criteria for the fraud assessment may be established based on one or more characteristics or information associated with the postal mail being flagged as potentially fraudulent or suspicious according to the conditions described above. In particular, the recipient or user may be identified as a target group, such as the elderly, disabled, children, etc., in which case the threshold for the fraud assessment may be lower (i.e., more sensitive to flagging a piece of postal mail as potentially fraudulent or suspicious). In some cases, action 318 may also be determined on the basis of the assessment. For example, where the criteria is a fraud assessment, the action performed by service provider 122 may be preventing delivery of the fraudulent piece of mail (e.g., first action 124, shown in FIG. 1 above).

In the case of a status assessment, a threshold associated with a criteria for the status assessment may be established based on one or more characteristics or information obtained from the captured information or the analysis of the user's mail history. For example, the criteria for the status assessment may be a predicted status of the recipient. The predicted status may be associated with a health of the recipient or may be an event associated with the recipient. Based on the analysis of the user's mail history and the plurality of characteristics, a user or recipient's health status may be determined, such as a mental, physical, or financial health. For example, the status assessment formed by the machine-learning algorithm may analyze information associated with postal mail from collection agencies or past due notices to determine a potential health issue with the user or recipient. Additionally, a large number of new subscriptions, services, or postal mail from financial institutions may indicate potential financial or mental issues.

Similarly, the status assessment formed by the machine-learning algorithm may analyze information associated with postal mail from similar new senders to determine a potential event associated with the user or recipient, such as a birth, marriage, wedding, attending a conference, vacation, moving, or new purchases.

Referring now to FIG. 4, an example embodiment of a piece of postal mail for assessment in the form of a letter 400 is shown. In this embodiment, a number of different information may be captured or obtained from an image of letter 400. For example, information associated with a sender 402 may be obtained, including a sender name or identity 404 and a sender's origination address 406. Information may also be obtained from a postmark 408, such as a processing location or facility or zipcode. Additionally, information associated with a recipient 410 may be obtained, including a recipient name or identity 412 and a recipient's delivery address 414. For example, discrepancies in delivery address 414 used by different senders may be analyzed by the machine-learning algorithm to identify or flag potentially fraudulent or suspicious mail.

In addition, name discrepancies may also be used as an additional analysis factor. For example, discrepancies in recipient name 412 or delivery address 414 used by different senders may be analyzed by the machine-learning algorithm to identify or flag potentially fraudulent or suspicious mail.

In some cases, the exterior of letter 400 may include other text, logos, or indicia that may be captured and used by the machine-learning algorithm to form an assessment. For example, as shown in FIG. 4, letter 400 may include a past due notice 416. Past due notice 416 and/or other similar indicia may be used by the machine-learning algorithm to form an assessment associated with a health of the user or recipient, such as mental health (i.e., the user or recipient is not paying bills on time which may indicate a cognitive issue), physical health (i.e., the user or recipient is not able to pay bills on time which may indicate a physical problem), and/or financial health (i.e., the user or recipient is not paying bills on time which may indicate a financial issue). Other key type identification may also be captured from the images of the exterior of letter 400, such as collection notices, official government logos, or other markers or indicia.

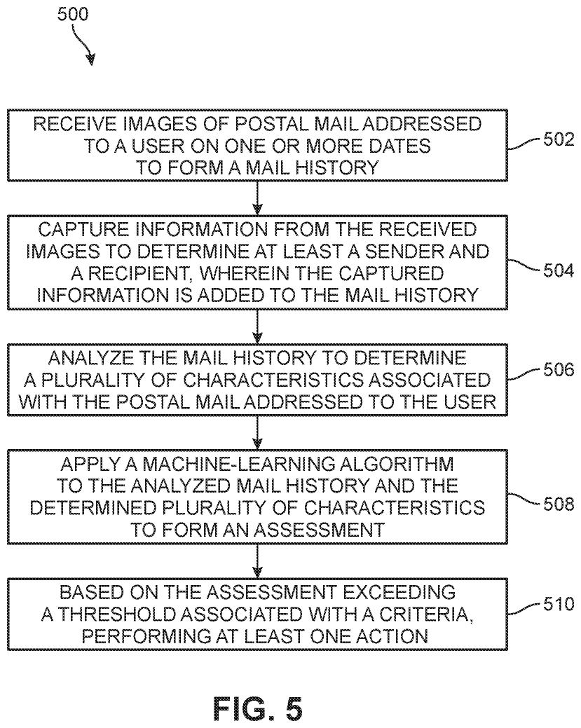

Referring now to FIG. 5, a flowchart of an example embodiment of a method 500 for forming an assessment of postal mail is illustrated. In an example embodiment, method 500 may be implemented by computing system 300 of service provider 122, as described above. In other embodiments, method 500 may be implemented by a processor of a computer of a third party or the user or recipient.

In this embodiment, method 500 begins at an operation 502. At operation 502, images of postal mail addressed to a user are received on one or more dates to form a mail history. For example, as shown in FIG. 2 above, scanned images 118 of plurality of pieces of postal mail 102 from post office 116 are received for multiple days of the week to form a mail history for user 202.

Next, method 500 includes an operation 504. At operation 504, information from the received images is captured to determine at least a sender and a recipient. The captured information from operation 504 is also added to the mail history for the user. For example, the captured information from operation 504 may include any of the information described above, including as shown in FIG. 4 above.

Method 500 proceeds to an operation 506, where the mail history is analyzed to determine a plurality of characteristics associated with the postal mail addressed to the user. For example, the characteristics may include frequency of mail and known or unknown relationships between senders and the recipient, as described above.

Next, method 500 includes an operation 508. At operation 508 a machine-learning algorithm is applied to the analyzed mail history and the determined plurality of characteristics from operation 506 to form an assessment. As described above, the assessment may include a fraud assessment and/or a status assessment, such as a health or an event associated with the user or recipient. Method 500 proceeds to an operation 510. Based on the assessment formed at operation 508 exceeding a threshold associated with a criteria, operation 510 includes performing at least one action. For example, as described above, the at least one action performed at operation 510 may include one or more of first action 124, second action 126, or third action 128 described above in reference to FIG. 1.

Method 500 may be subsequently repeated when new scanned images are received from the post office. As described above, the machine-learning algorithm may be trained so that additional information and assessments from previous iterations of method 500 may be used (e.g., as part of the user's mail history) to improve the assessments made during later iterations of method 500.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for forming an assessment of postal mail, the method comprising:
receiving images of postal mail addressed to a user on one or more dates to form a mail history;
capturing information from the received images to determine at least information associated with a sender and a recipient, wherein the captured information is added to the mail history;
analyzing the mail history to determine a plurality of characteristics associated with the postal mail addressed to the user;
applying a machine-learning algorithm to the analyzed mail history and the determined plurality of characteristics to form an assessment; and
based on the assessment exceeding a threshold associated with a criteria, performing at least one action.

2. The method according to claim 1, wherein the recipient is identified as a target group and wherein the criteria is a fraud assessment.

3. The method according to claim 2, wherein the action is preventing delivery of one or more pieces of postal mail identified as fraudulent.

4. The method according to claim 2, wherein the action is providing a notification to at least one entity.

5. The method according to claim 1, wherein the criteria is a status assessment of the recipient.

6. The method according to claim 5, wherein the status assessment is associated with a health of the recipient.

7. The method according to claim 5, wherein the status assessment is associated with an event associated with the recipient.

8. A computer program product for forming an assessment of postal mail, the computer program product comprising a computer readable storage medium having program instructions embodied therewith, the program instructions executable by a processor to cause the processor to perform a method comprising:
receiving images of postal mail addressed to a user on one or more dates to form a mail history;
capturing information from the received images to determine at least information associated with a sender and a recipient, wherein the captured information is added to the mail history;
analyzing the mail history to determine a plurality of characteristics associated with the postal mail addressed to the user;
applying a machine-learning algorithm to the analyzed mail history and the determined plurality of characteristics to form an assessment; and
based on the assessment exceeding a threshold associated with a criteria, performing at least one action.

9. The computer program product according to claim 8, wherein the recipient is identified as a target group and wherein the criteria is a fraud assessment.

10. The computer program product according to claim 9, wherein the action is preventing delivery of one or more pieces of postal mail identified as fraudulent.

11. The computer program product according to claim 9, wherein the action is providing a notification to at least one entity.

12. The computer program product according to claim 8, wherein the criteria is a status assessment of the recipient.

13. The computer program product according to claim 12, wherein the status assessment is associated with a health of the recipient.

14. The computer program product according to claim 12, wherein the status assessment is associated with an event associated with the recipient.

15. A system for forming an assessment of postal mail, the system comprising at least one computer including a processor configured to perform a method comprising:
receiving images of postal mail addressed to a user on one or more dates to form a mail history;
capturing information from the received images to determine at least information associated with a sender and a recipient, wherein the captured information is added to the mail history;
analyzing the mail history to determine a plurality of characteristics associated with the postal mail addressed to the user;
applying a machine-learning algorithm to the analyzed mail history and the determined plurality of characteristics to form an assessment; and
based on the assessment exceeding a threshold associated with a criteria, performing at least one action.

16. The system according to claim 15, wherein the at least one action includes preventing delivery of one or more pieces of postal mail and/or providing a notification to at least one entity.

17. The system according to claim 15, wherein the recipient is identified as a target group and wherein the criteria is a fraud assessment.

18. The system according to claim 15, wherein the criteria is a status assessment of the recipient.

19. The system according to claim 18, wherein the status assessment is associated with a health of the recipient.

20. The system according to claim 18, wherein the status assessment is associated with an event associated with the recipient.
